(19) United States
(12) Patent Application Publication
(10) Pub. No.: US 2008/0267349 A1
(43) Pub. Date: Oct. 30, 2008

(54) Particle Therapy

(76) Inventor: Eike Rietzel, Darmstadt (DE)

Correspondence Address: BRINKS HOFER GILSON & LIONE, P.O. BOX 10395, CHICAGO, IL, 60610, US

(21) Appl. No.: 12/092,771

(22) PCT Filed: Nov. 9, 2006
(86) PCT No.: PCT/EP06/68263

§ 371 Date: May 6, 2008

Related U.S. Application Data
(60) Provisional application No. 60/798,252, filed on May 5, 2006.

(30) Foreign Application Priority Data
Nov. 11, 2005 (DE) 10 2005 053 971.8

(51) Int. Cl. G01N 23/223

(52) U.S. Cl. 378/44

(57) ABSTRACT

A particle therapy facility has a particle accelerator, a therapy control system and at least one treatment room, where the particle accelerator accelerates particles and supplies them to the treatment room via an adaptation unit in order to irradiate a volume which is to be irradiated in a patient, and where the treatment room has a patient positioning device for positioning the patient relative to a scan area of the adaptation unit and at least one fluoroscopy system for continuously obtaining fluoroscopic image data from the patient in an area around the scan area, and where the therapy control system is designed for online evaluation of the fluoroscopic image data for movement of the volume which is to be irradiated and/or of the adjoining tissue and/or organs arranged around it and/or markers implanted in the patient which are depicted in the fluoroscopic images, and for output of a control signal for the adaptation unit which (control signal) adapts a particle beam direction and/or a particle energy to the movement, and/or for output of the control signal for a beam interruption unit for irradiating the volume which is to be irradiated on the basis of movement states.

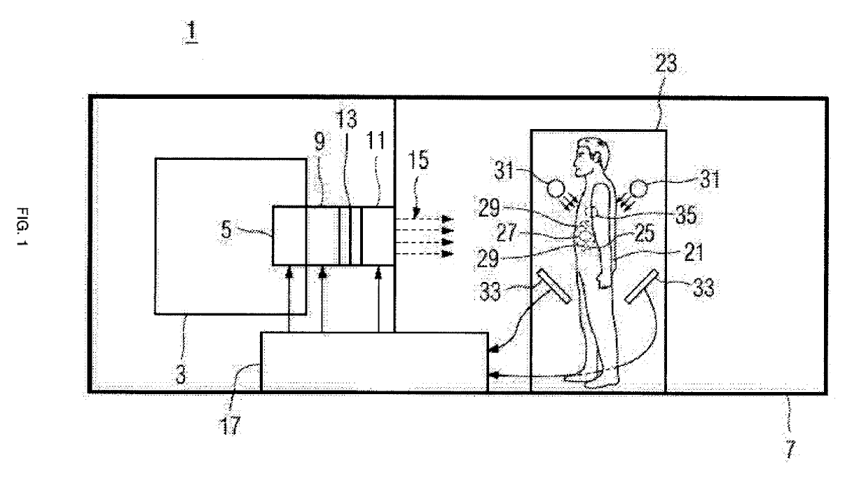

The invention relates to a particle therapy facility for irradiating a patient.

Fluoroscopy is a technique for obtaining real-time x-ray images of a patient. To this end, an x-ray beam—which is actuated for example by means of a switch—is directed through a patient onto a fluorescence plate, which is recorded by a camera using an image amplifier. The images obtained are pre-sented to a radiologist, e.g. on a monitor. Fluoroscopy is used in diagnostics and therapy, e.g. in order to observe instruments in the patient during the diagnosis or therapy.

A particle therapy facility usually has an accelerator unit and a high-energy beam guidance system. The acceleration of the particles, e.g. protons, pions, helium ions, carbon ions or oxygen ions, is done by means of a synchrotron, for example. The particles are usually preaccelerated by a linear accelerator and are fed into the synchrotron in order to be accelerated to the desired energy and stored for the irradiation process.

A high-energy beam transport system conducts the particles from the accelerator unit to one or more treatment rooms. A distinction is drawn between “fixed beam” treatment rooms, in which the particles hit the treatment position from a fixed direction, and so-called gantry-based treatment rooms. In the case of the latter, it is possible to direct the particle beam onto the patient from various directions.

A raster scan device is used to move the particle beam over a scan area. To this end, the beam is displaced laterally e.g. using two deflecting magnets. In that case, the irradiation is performed preferably on a volume-element-oriented basis, i.e. during the therapy planning the dose distribution which is to be applied is composed from subdoses which are delivered to different volume elements.

A control and safety system of the particle therapy facility ensures that a particle beam characterized by the requested parameters is conducted into the appropriate treatment room respectively. The parameters are defined in a so-called therapy plan. This defines how many particles should hit the patient or each of the volume elements, from what direction and with what energy. The energy of the particles determines the penetration depth of the particles into the patient, i.e. the location of the volume element at which the maximum interaction occurs with the tissue during the particle therapy; in other words, the location at which the maximum dose is deposited.

Usually beam monitoring elements are placed in front of the patient for monitoring e.g. the position and/or the intensity of the particle beam. The position of the particle beam and its beam profile are usually measured using suitable detectors, for example ionization chambers or multiple-channel chambers, which are situated along the beam path close to the patient during the treatment.

The patient is oriented relative to the scan area of the particle therapy facility using a patient positioning device in the treatment room. In order to verify the irradiation position of a preferably fixed patient, radioscopic images provided from a position verification unit are usually aligned with CT data which have been used for the therapy planning before the irradiation process starts, and the irradiation position of the patient is readjusted if necessary.

In radiotherapy, moving objects (e.g. due to breathing) are irradiated by gating the therapy beam on the basis of the movement. The movement can be monitored e.g. by means of an external image recording system, see S. Minohara et al., “Respiratory Gated Irradiation System for Heavy-ion Radio-therapy”, Int. J. Radiation Oncology Biol. Phys., Vol. 47, No. 4, pp. 1097-1103, 2000. A system for real-time tumor tracking for radiotherapy is known e.g. from H. Shirato, et al., “Physical Aspects of a Real-time Tumor-tracking System for Gated Radiotherapy”, Int. J. Radiation Oncology Biol. Phys., Vol. 48, No. 4, pp. 1187-1195, 2000. In addition, a method is known from WO 00/54689, in which internal markers depicted in periodically taken x-ray images are related to external markers in order to adapt the therapy to a target area.

The method disclosed in DE 100 31 074 A1 adapts the irradiation to a movement of the patient by observing the patient's surface. A deflecting unit deflects the particle beam in a lateral direction, and the scanning depth of the particle beam is controlled by a depth-scanning adaptation unit. Such an apparatus is also described in S. O. Grözinger, “Volume conformal irradiation of moving target volumes with scanned ion beams”, dissertation, TU Darmstadt, Dec. 2, 2004.

It is an object of the invention to improve the irradiation of moving objects during particle therapy.

The object is achieved by a particle therapy facility as claimed in claim 1.

In one embodiment the particle therapy facility has a particle accelerator, a therapy control system and at least one treatment room. The particle accelerator accelerates the particles to the energy required for treatment. A fine tuning of the energy can also be achieved e.g. by an adaptation unit arranged in the vicinity of the patient, i.e. in the region of the beam exit. In order to irradiate a patient, a particle beam is delivered to a volume located within a patient, which is positioned in the treatment room. The treatment room has a patient positioning device for positioning the patient relative to a scan area and at least one fluoroscopy system for continuously obtaining fluoroscopic image data from the patient, in particular from the area located around the scan area. The therapy control system is designed for online evaluation of the fluoroscopic image data in order to correct the irradiation parameters. Image identification algorithms can be used to identify, by way of example, a movement in the volume which is to be irradiated, a movement in tissue adjoining the volume which is to be irradiated, a movement in organs arranged around the volume which is to be irradiated and/or a movement of markers implanted in the patient which are depicted in the fluoroscopic images.

As a reaction to a movement, the therapy control system sends a control signal to the adaptation unit in order to adapt a particle beam direction and/or a particle energy according the movement, i.e. the particle beam follows the movement of the volume which is to be irradiated. This is referred to as tracking, the tracking being carried out on the basis of fluoroscopically obtained information about the interior of a patient (internal tracking).

In addition, it is alternatively or additionally possible to send a control signal to a beam interruption unit, said control signal causing the irradiation of the volume to be suspended intermittently on the basis of the movement status. I.e., if the volume which is to be irradiated is situated at a location where it cannot be irradiated, then the particle beam is temporarily blocked. This is referred to as gating (or gated therapy), the gating likewise being based on fluoroscopically obtained information about the interior of a patient (internal gating). Instead of turning off the particle beam, it can alternatively be temporarily directed at another volume element in order to irradiate that volume element.

Further advantageous embodiments of the invention are characterized by the features of the subclaims.

In comparison with the recording of external movements, which do not always allow an unambiguous conclusion to be drawn about the internal anatomy and hence the movement of the internal anatomy, the use of a fluoroscopy system allows the use of detection methods with high spatial resolutions. The anatomy recorded by fluoroscopic images presents internal information which allows e.g. the gating or tracking to be performed with high precision at the resolution of the fluoroscopic images. Particularly in particle therapy, where the range of the particles also plays a crucial part when delivering a desired dose distribution, this gain in precision is very desirable. In the case of dynamically applied particle beams, a gating or tracking based on the internal anatomy significantly reduces the risk of isolated under-irradiation and over-irradiation. Another advantage of the use of a fluoroscopy system is that the accuracy of the irradiation can be ensured and monitored continuously.

The mentioned advantages of the high spatial resolution of fluoroscopic images in three dimensions are complemented by advantages such as
a high level of time resolution (>30 Hz),
the presence of information about translations, rotations and density distributions,
monitoring over a long period (>10⁴ sec.),
a compact design for the fluoroscopy system around the patient, and
a high level of compatibility with raster scan technology, since fluoroscopy is insensitive toward stray magnetic fields and stray radiation.

Methods for suitable movement tracking with the aid of fluoroscopy are well known.

An exemplary embodiment of the invention is now described with reference to the FIGURE. The FIGURE illustrates a schematic of an exemplary particle therapy facility adapted to perform internally controlled gating or tracking.

The accelerator in a particle therapy facility 1 comprises a particle accelerator system 3 having at least one particle source, an accelerator and a high-energy beam guidance system and also units 5 for interrupting the supply of the particle beam to at least one treatment room 7. The accelerator accelerates the particles which reach energies e.g. of several 100 MeV in the case of protons. Close to the patient, it is possible to use a raster scan device 9 and/or an energy adaptation unit 11 to set beam parameters, for example, such as particle energy, beam direction and beam position. To monitor and verify the parameters of the particle beam, a beam monitoring unit 13 monitors the particle intensity, the particle beam position, the particle beam diameter, etc.

The raster scan device 9 allows the particle beam to be displaced in parallel fashion in a scan area 15 of 40 cm×40 cm, for example. A therapy control center 17 sets the beam parameters. The therapy control center 17 also controls and monitors the necessary settings on the accelerator and on the units located in the vicinity of the patient.

In the treatment room 7, a patient 21 is positioned on a patient positioning device 23 such that a volume 25 which is to be irradiated is placed within (or at least partly within) the scan area 15. The volume 25 which is to be irradiated comprises e.g. tumor tissue 27 which can be surrounded by additional tissue. The dimensions of the volume 25 which is to be irradiated have been defined during the therapy planning.

Markers 29 may additionally be placed during the therapy planning. The markers 29 allow an improved localization of the tumor tissue and an improved identification of any movements in fluoroscopic images.

In addition, the treatment room has a fluoroscopy system with x-ray sources 31 and x-ray detectors 33. X-ray sources 31 and x-ray detectors 33 are arranged such that x-ray beams are directed to the patient 21 at an angle, preferably of 90°, for example. This allows am identification of a movement of the volume 25 which is to be irradiated or a movement of the markers 29 or a movement of adjacent organs 35 in three dimensions.

In the FIGURE, the patient 21 is lying on his side and the volume which is to be irradiated is situated close to his lung. This means that the volume 25 which is to be irradiated is moved by respiration during breathing. To increase accuracy during particle irradiation, the fluoroscopy system is used to obtain images which are supplied to the therapy control center 17. The fluoroscopic images are analyzed using one or more image identification algorithms and, by way of example, time-dependent movement vectors for the volume 25 which is to be irradiated, for the tumor tissue 27, for the markers 29 and/or adjacent organs 35 are determined.

On the basis of the detected movement, the therapy control center 17 will recorrect the beam position during tracking using the raster scan device 9 and/or the energy adaptation device 11 in order to direct the particle beam onto the respective volume element which is to be irradiated.

During gating, the therapy control center 17 may alternatively or additionally control the timing of the supply of the particle beam using the beam interruption system 5. That means that no particle beam is applied if the volume elements which are to be irradiated in the volume 25 which is to be irradiated are in the wrong positions.

In other words, the patient 21 is monitored using one or more fluoroscopy systems during application of the particle beam in the operation of the particle therapy facility 1. In this case, the movement in the internal anatomy is recorded automatically and gating and tracking are implemented using the internal movements. The fluoroscopic monitoring of the patient can take place simultaneously using one or more image series in this case. By way of example, the FIGURE presents an embodiment with two image chains whose image axes are at an angle of 90° to one another. Other angles for the image axes relative to one another are also conceivable, but they should preferably be as close as possible to an angle of 90° relative to one another. Particular advantages are obtained particularly when a particle beam is being used which is dynamically applied. Thus, the use of a fluoroscopy system in conjunction with markers implanted in the patient allows the respective current movement state to be recorded with a high level of accuracy and online.

1. A particle therapy system, comprising:
a treatment room including a patient positioning device for positioning a patient relative to a scan area of a adaptation unit and at least one fluoroscopy system for continuously obtaining fluoroscopic image data from the patient in an area around the scan area;
a particle accelerator that accelerates particles and supplies them to the treatment room via the adaptation unit to irradiate a volume in the patient; and
a therapy control system that is operable to evaluate the fluoroscopic image data with respect to movement of the volume, the adjoining tissue, organs arranged around the volume, markers implanted in the patient which are depicted in the fluoroscopic images, or a combination thereof; and operable to output a control signal for the adaptation unit, the control signal adapting a particle beam direction and/or a particle energy with respect to the movement, and operable to output a control signal for a beam interruption unit for irradiating the volume on the basis of movement states.

2. The particle therapy system as claimed in claim 1, wherein the fluoroscopy system comprises at least two image series producing units, wherein at least two image series are arranged at an angle of greater than 45° relative to each other.

3. The particle therapy system as claimed in claim 1, wherein the adaptation unit has deflecting magnets of a raster scan device, a particle energy adaptation unit, or the combination thereof, particularly based on a wedge system that can be introduced into the particle beam, which are able to be actuated by the therapy control center in order to react to detected movements.

4. The particle therapy system as claimed in claim 1, wherein the particles of the particle beam are protons.

5. The particle therapy system as claimed in one claim 1, wherein the particles of the particle beam are pions, helium ions, carbon ions, or oxygen ions.

6. A particle therapy system, comprising:
a particle accelerator that accelerates particles and supplies them to a treatment room via an adaptation unit in order to irradiate a volume in a patient, the treatment room comprising: a patient positioning device for positioning the patient relative to a scan area of the adaptation unit and at least one fluoroscopy system for continuously obtaining fluoroscopic image data from the patient in an area around the scan area; and
a therapy control system is operable for online evaluation of the fluoroscopic image data with respect to movement of the volume, the adjoining tissues, organs arranged around it the volume, markers implanted in the patient that are depicted in the fluoroscopic images, or any combination thereof, and is operable for output of a control signal for a beam interruption unit for irradiating the volume on the basis of movement states.

7. The particle therapy system as claimed in claim 6, wherein the fluoroscopy system comprises at least two image series producing units, wherein at least two image series are arranged at an angle of greater 45° relative to each other.

8. The particle therapy system as claimed in claim 6, wherein the adaptation unit has deflecting magnets of a raster scan device and/or a particle energy adaptation unit, on the adaptation unit being a wedge system that can be introduced into the particle beam, which are able to be actuated by the therapy control center in order to react to detected movements.

9. The particle therapy system as claimed in claim 6, wherein the particles of the particle beam are protons.

10. The particle therapy facility as claimed in claim 6, wherein the particles of the particle beam are pions, helium ions, carbon ions or oxygen ions.

11. A particle therapy system, comprising: a particle accelerator, a therapy control system and at least one treatment room,
wherein the particle accelerator accelerates particles and supplies them to the treatment room via an adaptation unit in order to irradiate a volume that is to be irradiated in a patient,
wherein the treatment room has a patient positioning device that is operable to position the patient relative to a scan area of the adaptation unit and at least one fluoroscopy system for continuously obtaining fluoroscopic image data from the patient in an area around the scan area, and
wherein the therapy control system is operable for online evaluation of the fluoroscopic image data with respect to movement of the volume which is to be irradiated, and of the adjoining tissue, organs arranged around the volume, markers implanted in the patient which are depicted in the fluoroscopic images, or any combination thereof, and for output of a control signal for the adaptation unit, the control signal adapting a particle beam direction and/or a particle energy with respect to the movement.

12. The particle therapy system as claimed in claim 11, wherein the fluoroscopy system comprises at least two image series producing units, wherein at least two image series are arranged at an angle of greater than 45 to each other.

13. The particle therapy system as claimed in claim 11, wherein the adaptation unit has deflecting magnets of a raster scan device and/or a particle energy adaptation unit, particularly based on a wedge system which can be introduced into the particle beam, which are able to be actuated by the therapy control center in order to react to detected movements.

14. The particle therapy system as claimed in claim 11, wherein the particles of the particle beam are protons.

15. The particle therapy system as claimed in claim 11, wherein the particles of the particle beam are pions, helium ions, carbon ions or oxygen ions.

16. The particle therapy system as claimed in claim 1, wherein the fluoroscopic images are evaluated online.

17. The particle therapy system as claimed in claim 2, wherein the at least two image series are arranged at an angle of close to 90° to each other.

18. The particle therapy system as claimed in claim 6, wherein the at least two image series are arranged at an angle of close to 90° to each other.

19. The particle therapy system as claimed in claim 12, wherein the at least two image series are arranged at an angle of close to 90° to each other.
